(19) United States
(12) Patent Application Publication
(10) Pub. No.: US 2015/0083445 A1
(43) Pub. Date: Mar. 26, 2015

(54) IN-VEHICLE FIRE EXTINGUISHER

(71) Applicant: Panasonic Corporation, Osaka (JP)

(72) Inventors: Satoru Itani, Kanagawa (JP); Kenji Sugihara, Tokyo (JP)

(21) Appl. No.: 14/387,434

(22) PCT Filed: Mar. 25, 2013
(86) PCT No.: PCT/JP2013/002026

§ 371 Date: Sep. 23, 2014

(30) Foreign Application Priority Data
Mar. 26, 2012 (JP) 2012-068961

(51) Int. Cl. A62C 3/07

(52) U.S. Cl. CPC A62C 3/07
USPC 169/62

(57) ABSTRACT

The present invention reliably extinguishes fires in devices that have exceeded the guaranteed temperature without the use of a sensor. An in-vehicle fire extinguisher (100) extinguishes fires using an air conditioner for heating or cooling the interior of a vehicle compartment. A coolant discharged from a compressor (101) is pumped into the compressor (101) through a circulation path (106) via a condenser (102), an expansion valve (103) and an evaporator (105). A fire extinguishing unit (104) is provided to the circulation path (106) between the expansion valve (103) and the compressor (101). When a device mounted in a vehicle exceeds the guaranteed temperature, the fire extinguishing unit (104) melts so that coolant pumped from the circulation path (106) is discharged to the exterior and extinguishes the device fire.

### TECHNICAL FIELD

The present invention relates to an in-vehicle fire extinguishing apparatus that performs fire extinguishing by utilizing an air conditioning apparatus that heats or cools the vehicle interior.

### BACKGROUND ART

Conventionally, a fire extinguishing device disclosed in PTL 1 has been known in which, when an abnormality detection sensor detects an abnormality of a storage battery such as an abrupt change in temperature, a flame-retardant refrigerant circulating in a refrigeration circuit in a cooling device is discharged into a battery pack through a discharge pipe. According to PTL 1, by using refrigerant as a fire extinguishing agent, fire extinguishing can be promptly performed even when fire occurs in the storage battery.

### CITATION LIST

### Patent Literature

### PTL 1

### Japanese Patent Application Laid-Open No. 2010-110356

### SUMMARY OF INVENTION

### Technical Problem

However, in PTL 1, since fire extinguishing is performed when the abnormality detection sensor detects an abnormality, fire extinguishing cannot be performed in the case where the abnormality detection sensor is broken or damaged by impact or the like applied to the vehicle from the outside.

An object of the present invention is to provide an in-vehicle fire extinguishing apparatus that can surely perform fire extinguishing and the like, by performing the fire extinguishing without using a sensor.

### Solution to Problem

An in-vehicle fire extinguishing apparatus of an embodiment of the present invention is configured to perform fire extinguishing by utilizing an air conditioning apparatus that heats or cools a vehicle interior, the in-vehicle fire extinguishing apparatus including: an incombustible or flame-retardant refrigerant; a compressor that compresses the refrigerant in such a manner as to increase a temperature and a pressure of the refrigerant; a condenser that causes a high-temperature and high-pressure refrigerant compressed by the compressor to release heat; an expansion valve that expands the refrigerant that is caused to release heat by the condenser in such a manner as to reduce the temperature and the pressure of the refrigerant; an evaporator that causes a low-temperature and low-pressure refrigerant expanded by the expansion valve to absorb heat; a circulation path that causes the refrigerant output from the compressor to enter the compressor through the condenser, the expansion valve, and the evaporator; and a fire extinguishing section provided in the circulation path between the expansion valve and the compressor, the fire extinguishing section allowing the refrigerant entered from the circulation path to be output to the circulation path under an environment of a temperature below a predetermined temperature equal to or greater than a guaranteed temperature of a device mounted in a vehicle, and emitting the refrigerant entered from the circulation path to an exterior so as to perform fire extinguishing by being melted under an environment of a temperature equal to or greater than the predetermined temperature.

### Advantageous Effects of Invention

According to the present invention, fire extinguishing and the like can be surely performed, by performing the fire extinguishing without using a sensor.

### BRIEF DESCRIPTION OF DRAWINGS

FIG. 1 is a block diagram illustrating a configuration of an in-vehicle fire extinguishing apparatus according to Embodiment 1 of the present invention;

FIG. 2 is a perspective view of a fire extinguishing section in Embodiment 1 of the present invention;

FIG. 3 is a sectional view taken along line A-A of FIG. 2 illustrating a state where a closure section in Embodiment 1 of the present invention is not yet melted;

FIG. 4 is a sectional view taken along line A-A of FIG. 2 illustrating a state where the closure section in Embodiment 1 of the present invention has been melted;

FIG. 5 is a perspective view of a charger on which the fire extinguishing section in Embodiment 1 of the present invention is attached;

FIG. 6 is an enlarged sectional view of a main part of a fire extinguishing section in Embodiment 2 of the present invention;

FIG. 7 is an enlarged sectional view of a main part of a fire extinguishing section in Embodiment 3 of the present invention;

FIG. 8 is an enlarged sectional view of a main part of a fire extinguishing section in Embodiment 4 of the present invention; and

FIG. 9 is an enlarged sectional view of a main part of a fire extinguishing section in Embodiment 5 of the present invention.

### DESCRIPTION OF EMBODIMENTS

In the following, embodiments of the present invention will be described in detail with reference to the accompanying drawings.

### Embodiment 1

### Configuration of In-Vehicle Fire Extinguishing Apparatus

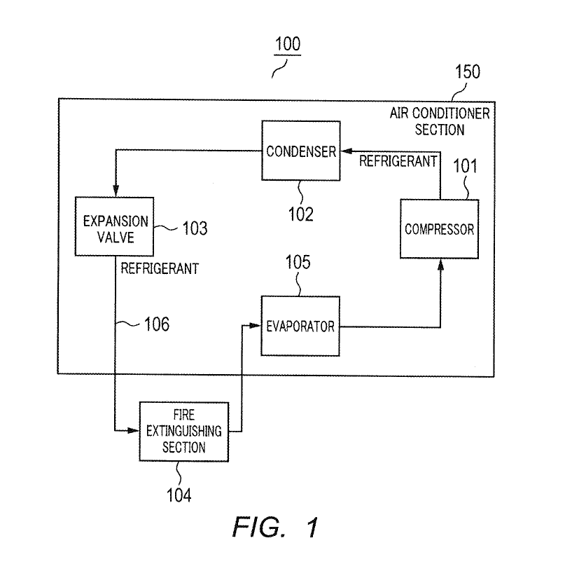

A configuration of in-vehicle fire extinguishing apparatus 100 according to Embodiment 1 of the present invention is described with reference to FIG. 1. FIG. 1 is a block diagram illustrating a configuration of in-vehicle fire extinguishing apparatus 100 according to an embodiment of the present embodiment.

In-vehicle fire extinguishing apparatus 100 includes compressor 101, condenser 102, expansion valve 103, fire extinguishing section 104, evaporator 105, and circulation path 106.

Air conditioning section 150 includes compressor 101, condenser 102, expansion valve 103, evaporator 105, and circulation path 106. Air conditioning section 150 serves as an air conditioning apparatus, and heats or cools the vehicle interior.

Compressor 101 compresses refrigerant having entered from evaporator 105 through circulation path 106 so as to increase the temperature and pressure of the refrigerant. Compressor 101 supplies the high-temperature and high-pressure refrigerant to condenser 102 through circulation path 106. Here, the refrigerant is incombustible or flame-retardant, and, for example, carbon dioxide, HFC-134a or HF0-1234yf is used as the refrigerant. An incombustible refrigerant is difficult to ignite, and does not continuously burn. A flame-retardant refrigerant is difficult to ignite, and even when it is ignited and combustion is continued, the speed is extremely low. In the present invention, an incombustible refrigerant is preferably used.

Condenser 102 causes the high-temperature and high-pressure refrigerant having entered from compressor 101 through circulation path 106 to release heat so as to liquefy the refrigerant, and supplies the liquefied refrigerant to expansion valve 103 through circulation path 106. The heat released from the refrigerant in condenser 102 heats up the vehicle interior.

Expansion valve 103 expands the refrigerant having entered from condenser 102 through circulation path 106 so as to reduce the temperature and pressure of the refrigerant. Expansion valve 103 supplies the low-temperature and low-pressure refrigerant to fire extinguishing section 104 through circulation path 106.

Under an environment of a predetermined temperature below a guaranteed temperature of a device mounted on the vehicle (hereinafter referred to as “fire extinguishing start temperature”), fire extinguishing section 104 supplies the low-temperature and low-pressure refrigerant having entered from expansion valve 103 through circulation path 106 to evaporator 105 through circulation path 106. Under an environment of the fire extinguishing start temperature or above, a part of fire extinguishing section 104 is melted, and the low-temperature and low-pressure refrigerant having entered from expansion valve 103 through circulation path 106 is emitted out of in-vehicle fire extinguishing apparatus 100, whereby fire extinguishing is performed. Here, the refrigerant having entered fire extinguishing section 104 from expansion valve 103 through circulation path 106 has a pressure higher than that of the outside air. It is to be noted that details of the configuration of fire extinguishing section 104 will be described later.

Here, examples of the device mounted in the vehicle include a motor, a charger, a battery, and an ECU. A guaranteed temperature of a device includes an operation guarantee temperature and a storage guarantee temperature. The operation guarantee temperature of a device is a temperature at which the device can normally function. When the device is used at a temperature greater than the operation guarantee temperature, the device does not normally operate, or the lifetime of the device is shortened from the guarantee lifetime. The operation guarantee temperature of a device mounted in an electric automobile provided with no engine is, for example, 125° C. In the case where the operation guarantee temperature of a device mounted in an electric automobile provided with no engine is 125° C., the fire extinguishing start temperature is set to, for example, 150° C. In addition, the storage guarantee temperature of a device is a temperature at which the possibility that the device is broken is high. The storage guarantee temperature of a device mounted in an electric automobile provided with no engine is, for example, 150° C. In the case where the storage guarantee temperature of a device mounted in an electric automobile provided with no engine is 150° C., the fire extinguishing start temperature is set to a temperature greater than 150° C. It is to be noted that the fire extinguishing start temperature may be the same as the operation guarantee temperature or the storage guarantee temperature of the device mounted in the vehicle.

Evaporator 105 evaporates the refrigerant having entered from fire extinguishing section 104 through circulation path 106 such that the refrigerant absorbs heat, and then evaporator 105 supplies the refrigerant having absorbed the heat to compressor 101 through circulation path 106. When heat is absorbed by the refrigerant in evaporator 105, the vehicle interior is cooled.

Circulation path 106 circulates the refrigerant output from compressor 101 through condenser 102, expansion valve 103, fire extinguishing section 104, evaporator 105 and compressor 101, in the named order.

### <Configuration of Fire Extinguishing Section>

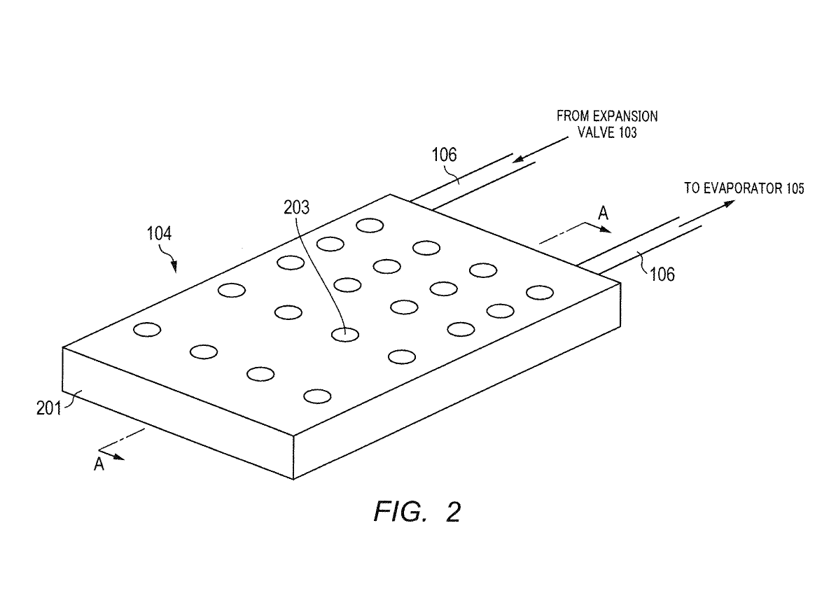

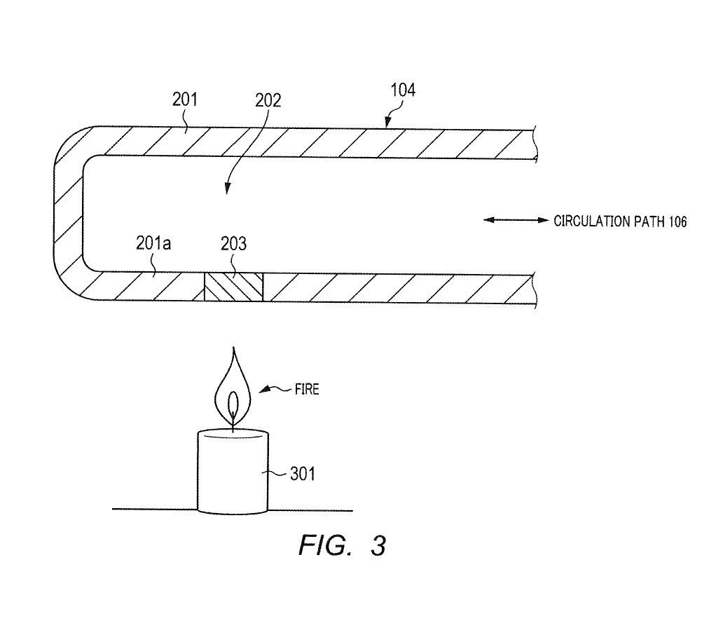

The configuration of fire extinguishing section 104 in Embodiment 1 of the present invention is described with reference to FIG. 2 and FIG. 3. FIG. 2 is a perspective view of fire extinguishing section 104 in the present embodiment. FIG. 3 is a sectional view taken along line A-A of FIG. 2 illustrating a state where closure section 203 is not yet melted.

Fire extinguishing section 104 includes fire extinguishing board 201, void 202 (see FIG. 3), and closure section 203.

Fire extinguishing board 201 has a plate-shape. Fire extinguishing board 201 is provided with closure section 203.

Void 202 is surrounded by wall section 201a. Refrigerant enters void 202 from circulation path 106, and the refrigerant having entered void 202 is output to circulation path 106.

Closure section 203 is formed of a material different from that of fire extinguishing board 201. Closure section 203 is formed of a material that is melted by a temperature greater than the fire extinguishing start temperature, and closure section 203 is attached to fire extinguishing board 201. For example, closure section 203 is formed of a fusible alloy which is used for thermal fuses, and closure section 203 is attached to fire extinguishing board 201. In addition, closure section 203 may be formed of tin or a solder and attached to fire extinguishing board 201 such that closure section 203 is melted at the fusing point of tin or solder. When closure section 203 is formed of a solder, closure section 203 can be melted at, for example, 183° C.

Closure section 203 is provided in wall section 201a that separates void 202 from the exterior in fire extinguishing section 104. For example, closure section 203 is attached to wall section 201a by welding. As viewed in the thickness cross-section of wall section 201a, closure section 203 is formed in a rectangular shape (see FIG. 3). When provided in wall section 201a, closure section 203 seals void 202 from the exterior.

Under an environment of a temperature below the fire extinguishing start temperature, the state where closure section 203 is provided in fire extinguishing board 201 is maintained. Thus, the refrigerant having entered void 202 from circulation path 106 is output to circulation path 106 without being emitted to the exterior of fire extinguishing section 104. In addition, under an environment of the fire extinguishing start temperature or above, closure section 203 is melted by heat. Thus, the refrigerant having entered void 202 from circulation path 106 is emitted out of fire extinguishing section 104. Here, at the time of extinguishing fire, the entirety of closure section 203 is not have to be melted as long as the refrigerant having entered void 202 is emitted out of fire extinguishing section 104. In view of this, the melting of closure section 203 includes the case where the entirety of closure section 203 is melted and the case where a part of closure section 203 is melted.

A predetermined pressure is exerted on closure section 203 by the refrigerant having entered void 202, and therefore, closure section 203 is so provided in fire extinguishing board 201 as not to be dropped off from fire extinguishing board 201 by the pressure of the refrigerant under an environment of a temperature below the fire extinguishing start temperature.

### <Fire Extinguishing Method>

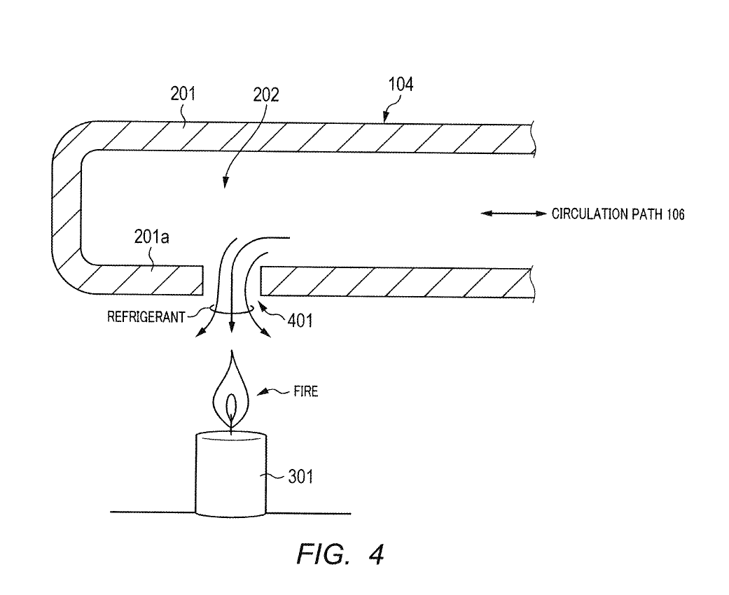

A fire extinguishing method in Embodiment 1 of the present invention is described with reference to FIG. 3 and FIG. 4. FIG. 4 is a sectional view taken along line A-A of FIG. 2 illustrating a state where closure section 203 has been melted.

Referring to FIG. 3, closure section 203 is heated and melted by fire when fire occurs at device 301, under an environment of the fire extinguishing start temperature or above. When part of closure section 203 is melted, or when closure section 203 is melted and dropped off from fire extinguishing board 201 as illustrated in FIG. 4, through hole 401 that connects void 202 and the exterior is defined in fire extinguishing board 201. In this state, the refrigerant having entered void 202 is emitted to device 301 and the area around device 301 from through hole 401, so as to extinguish the fire.

At this time, before closure section 203 is melted, wall section 201a and closure section 203 are under a predetermined pressure exerted by the refrigerant having entered void 202. Accordingly, the refrigerant which is emitted from through hole 401 when closure section 203 is melted has a certain force caused by the release of the pressure.

### <Exemplary Use of Fire Extinguishing Section>

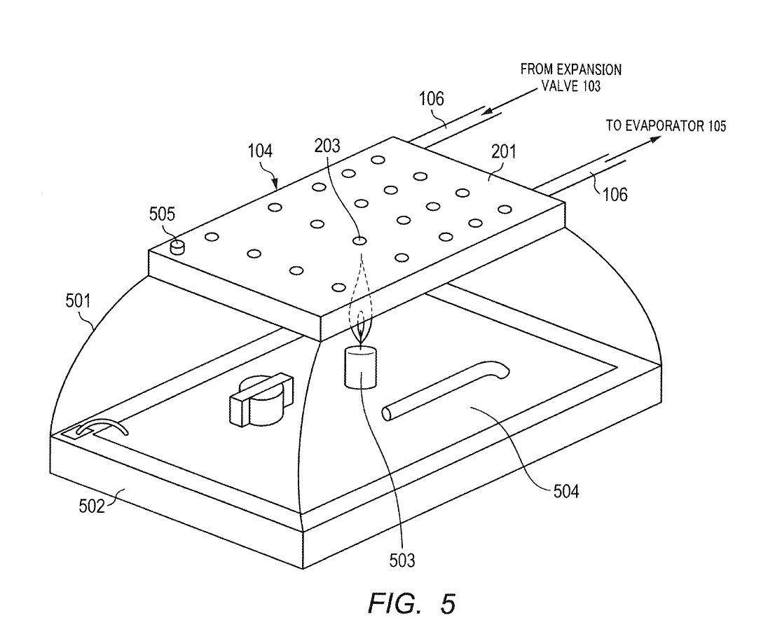

An exemplary use of fire extinguishing section 104 in Embodiment 1 of the present invention is described with reference to FIG. 5. FIG. 5 is a perspective view of charger 502 on which fire extinguishing section 104 in the present embodiment is attached.

As illustrated in FIG. 5, fire extinguishing section 104 is attached to charger 502 through cover 501.

Cover 501 covers the space between fire extinguishing section 104 and charger 502.

Between cover 501 and charger 502, power source circuit section 504 on which device 503 is mounted is housed. On the upper side of cover 501, fire extinguishing section 104 is attached.

In FIG. 5, fire extinguishing board 201 includes pressure-regulating valve 505. Pressure-regulating valve 505 adjusts the pressure of the refrigerant having entered void 202 exerted on fire extinguishing board 201.

In the above-mentioned configuration, when fire is caused by ignited device 503, closure section 203 is melted. Thus, the refrigerant having entered fire extinguishing board 201 from circulation path 106 is scattered to power source circuit section 504 so as to extinguish fire.

### <Effect of the Present Embodiment>

According to the present embodiment, fire or the like can be surely extinguished by performing fire extinguishing without using a sensor.

In addition, according to the present embodiment, the closure section has a simple rectangular shape in the thickness cross-section of the wall section forming the fire extinguishing section. Thus, the closure section can be readily formed, and the calculation of the pressure of the refrigerant exerted on the closure section can be easily performed, and in addition, the temperature at which the closure section is melted can be readily set since the calculation of the heat conduction characteristics in the closure section is readily performed.

In addition, according to the present embodiment, when a pressure-regulating valve is provided in the fire extinguishing section, it is possible to prevent the closure section from being dropped off from the fire extinguishing board by the pressure of the refrigerant exerted on the closure section, under an environment of a temperature below the fire extinguishing start temperature.

### <Modification of the Present Embodiment>

While the closure section has a rectangular shape in the thickness cross-section of the wall section of the fire extinguishing board in the present embodiment, the present invention is not limited to this, and the closure section may have a square shape in the thickness cross-section of the wall section of the fire extinguishing board.

### Embodiment 2

### Configuration of Fire Extinguishing Section

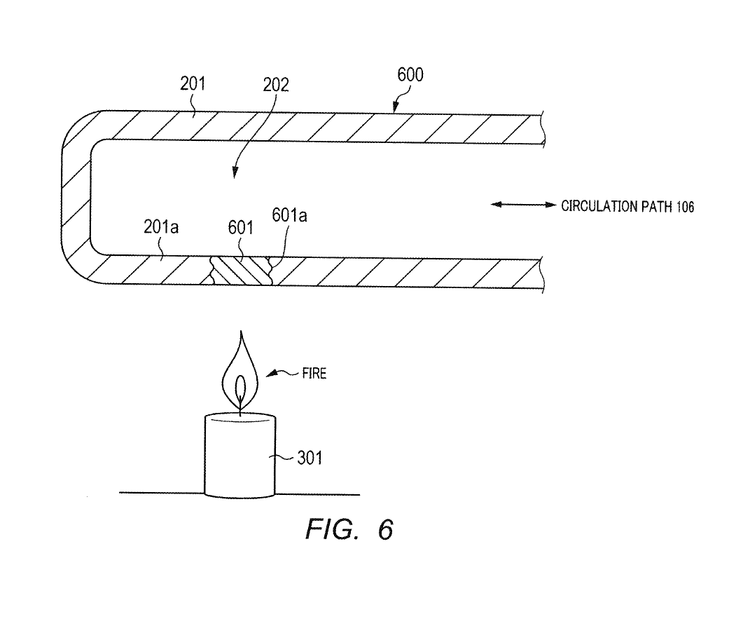

The configuration of fire extinguishing section 600 in Embodiment 2 of the present invention is described with reference to FIG. 6. FIG. 6 is an enlarged sectional view of a main part of fire extinguishing section 600 in the present embodiment.

As compared with fire extinguishing section 104 according to Embodiment 1 illustrated in FIG. 2 and FIG. 3, fire extinguishing section 600 illustrated in FIG. 6 includes closure section 601 in place of closure section 203. It is to be noted that, in FIG. 6, the same reference numerals are attached to the components same as those in FIG. 2 to FIG. 4, and the descriptions thereof are omitted. In addition, the in-vehicle fire extinguishing apparatus according to the embodiment of the present embodiment has the same configuration as that illustrated in FIG. 1, and the description thereof is omitted.

Fire extinguishing section 600 includes fire extinguishing board 201, void 202, and closure section 601.

Fire extinguishing board 201 is provided with closure section 601.

Closure section 601 is formed of a material different from that of fire extinguishing board 201. Closure section 601 is formed of a material that melts under an environment of the fire extinguishing start temperature or above, and is attached to fire extinguishing board 201. The material of closure section 601 is same as that of closure section 203 of Embodiment 1, and the description thereof is omitted.

Closure section 601 is provided in wall section 201a that separates void 202 from the exterior in fire extinguishing section 600. Closure section 601 has irregularity on side wall 601a, and is engaged with wall section 201a by the irregularity. When provided in wall section 201a, closure section 601 seals void 202 from the exterior.

Under an environment of a temperature below the fire extinguishing start temperature, the state where closure section 601 is provided in fire extinguishing board 201 is maintained. Thus, the refrigerant having entered void 202 from circulation path 106 is output to circulation path 106 without being emitted to the exterior of fire extinguishing section 600. In addition, under an environment of the fire extinguishing start temperature or above, closure section 601 is melted by heat. Thus, the refrigerant having entered void 202 from circulation path 106 is emitted out of fire extinguishing section 600.

A predetermined pressure is exerted on closure section 601 by the refrigerant having entered void 202, and therefore, closure section 601 is so provided in fire extinguishing board 201 as not to be dropped off from fire extinguishing board 201 by the pressure of the refrigerant under an environment of a temperature below the fire extinguishing start temperature.

### <Fire Extinguishing Method>

A fire extinguishing method in Embodiment 2 of the present invention is described with reference to FIG. 6.

Referring to FIG. 6, closure section 601 is heated and melted by fire when fire occurs at device 301, under an environment of the fire extinguishing start temperature or above. At this time, the protruding parts of the irregularity of side wall 601a of closure section 601 are melted, and closure section 601 drops off from fire extinguishing board 201, or a gap is defined between side wall 601a and wall section 201a. Accordingly, through the through hole defined after closure section 601 drops off, or through the through hole in the form of the gap defined between side wall 601a and wall section 201a, the refrigerant can be emitted out of void 202.

It is to be noted that the other points of the fire extinguishing method in the present embodiment are same as in Embodiment 1, and the description thereof is omitted.

### <Effect of the Present Embodiment>

According to the present invention, fire or the like can be surely extinguished by performing fire extinguishing without using a sensor to detect temperature changes.

In addition, according to the present embodiment, since the closure section is engaged by the irregularity with the wall section of the fire extinguishing board, it is possible to securely prevent the closure section from dropping off due to the shock and the pressure of the refrigerant applied to the in-vehicle fire extinguishing apparatus.

In addition, according to the present embodiment, the closure section and the fire extinguishing board are engaged with each other by the irregularity, and, under an environment of the fire extinguishing start temperature or above, the refrigerant can be emitted to the exterior by only melting the protruding part of the side wall of the closure section. Thus, the closure section can be melted with low energy, and fire can be extinguished at an early stage.

In addition, according to the present embodiment, when a pressure-regulating valve is provided in the fire extinguishing section, it is possible to prevent the closure section from being dropped off from the fire extinguishing board by the pressure of the refrigerant exerted on the closure section, under an environment of a temperature below the fire extinguishing start temperature.

### Embodiment 3

### Configuration of Fire Extinguishing Section

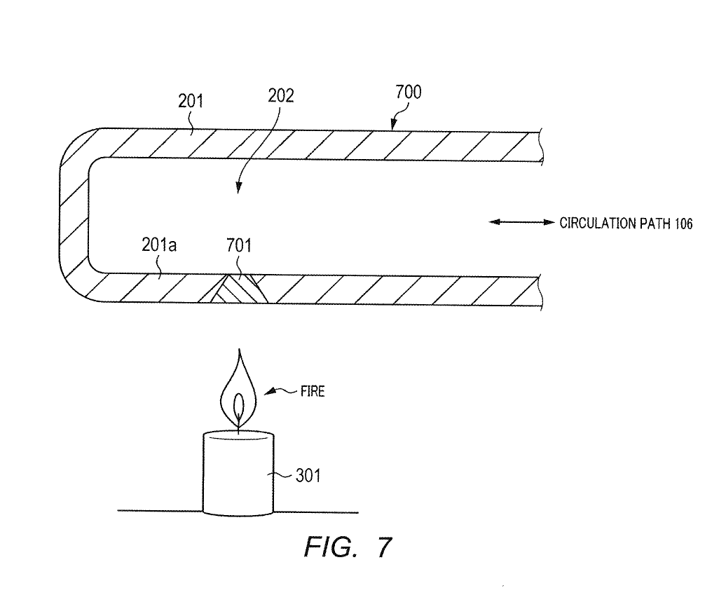

The configuration of fire extinguishing section 700 in Embodiment 3 of the present invention is described with reference to FIG. 7. FIG. 7 is an enlarged sectional view of a main part of fire extinguishing section 700 in the present embodiment.

As compared with fire extinguishing section 104 according to Embodiment 1 illustrated in FIG. 2 and FIG. 3, fire extinguishing section 700 illustrated in FIG. 7 includes closure section 701 in place of closure section 203. It is to be noted that, in FIG. 7, the same reference numerals are attached to the components same as those in FIG. 2 to FIG. 4, and the descriptions thereof are omitted. In addition, the configuration of the in-vehicle fire extinguishing apparatus according to the embodiment of the present embodiment is same as that of FIG. 1, and the description thereof is omitted.

Fire extinguishing section 700 includes fire extinguishing board 201, void 202, and closure section 701.

Fire extinguishing board 201 is provided with closure section 701.

Closure section 701 is formed of a material different from that of fire extinguishing board 201. Closure section 701 is formed of a material that is melted by a temperature greater than the fire extinguishing start temperature, and closure section 701 is attached to fire extinguishing board 201. The material of closure section 701 is same as that of closure section 203 of Embodiment 1, and the description thereof is omitted.

Closure section 701 is provided in wall section 201a that separates void 202 from the exterior in fire extinguishing section 700. As viewed in the thickness cross-section of wall section 201a, closure section 701 has a form tapering from the exterior toward void 202 of fire extinguishing section 700. When provided in wall section 201a, closure section 701 seals void 202 from the exterior.

Under an environment of a temperature below the fire extinguishing start temperature, the state where closure section 701 is provided in fire extinguishing board 201 is maintained. Thus, the refrigerant having entered void 202 from circulation path 106 is output to circulation path 106 without being emitted to the exterior of fire extinguishing section 700. In addition, under an environment of the fire extinguishing start temperature or above, closure section 701 is melted by heat. Thus, the refrigerant having entered void 202 from circulation path 106 is emitted out of fire extinguishing section 700.

A predetermined pressure is exerted on closure section 701 by the refrigerant having entered void 202, and therefore, closure section 701 is so provided in fire extinguishing board 201 as not to be dropped off from fire extinguishing board 201 by the pressure of the refrigerant under an environment of a temperature below the fire extinguishing start temperature.

It is to be noted that the other points of the fire extinguishing method in the present embodiment are same as in Embodiment 1, and the description thereof is omitted.

### <Effect of the Present Embodiment>

According to the present invention, fire or the like can be surely extinguished by performing fire extinguishing without using a sensor to detect temperature changes.

In addition, according to the present embodiment, the closure section has a form tapering from the exterior toward the interior of the fire extinguishing section as viewed in the thickness cross-section of the wall section. Thus, since the size of the surface area contacting the refrigerant can be reduced, the influence of the pressure of the refrigerant can be minimized, and the area heated by fire when fire is caused can be increased. Thus, the closure section can be melted with low energy, and fire can be extinguished at an early stage.

In addition, according to the present embodiment, when a pressure-regulating valve is provided in the fire extinguishing section, it is possible to prevent the closure section from being dropped off from the fire extinguishing board by the pressure of the refrigerant exerted on the closure section, under an environment of a temperature below the fire extinguishing start temperature.

### Embodiment 4

### Configuration of Fire Extinguishing Section

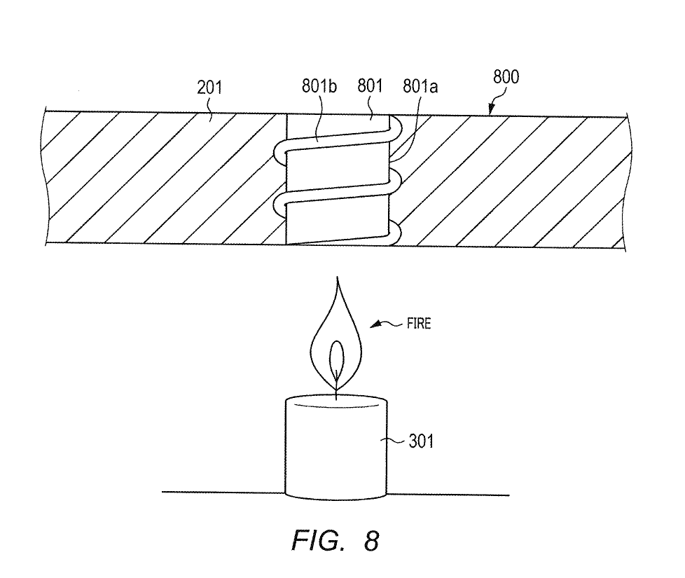

The configuration of fire extinguishing section 800 in Embodiment 4 of the present invention is described with reference to FIG. 8. FIG. 8 is an enlarged sectional view of a main part of fire extinguishing section 800 in the present embodiment.

As compared with fire extinguishing section 104 according to Embodiment 1 illustrated in FIG. 2 and FIG. 3, fire extinguishing section 800 illustrated in FIG. 8 includes closure section 801 in place of closure section 203. It is to be noted that, in FIG. 8, the same reference numerals are attached to the components same as those in FIG. 2 to FIG. 4, and the descriptions thereof are omitted. In addition, the configuration of the in-vehicle fire extinguishing apparatus according to the embodiment of the present embodiment is same as that of FIG. 1, and the description thereof is omitted.

Fire extinguishing section 800 includes fire extinguishing board 201, void 202 (omitted in FIG. 8), and closure section 801.

Fire extinguishing board 201 is provided with closure section 801.

Closure section 801 is formed of a material different from that of fire extinguishing board 201. Closure section 801 is formed of a material that is melted by a temperature greater than the fire extinguishing start temperature, and closure section 801 is attached to fire extinguishing board 201. The material of closure section 801 is same as that of closure section 203 of Embodiment 1, and the description thereof is omitted.

Closure section 801 is provided in wall section 201a that separates void 202 from the exterior in fire extinguishing section 800. In closure section 801, screw thread 801b is formed on side wall 801a, and screw thread 801b is threadedly engaged with wall section 201a. When provided in wall section 201a, closure section 801 seals void 202 from the exterior.

Under an environment of a temperature below the fire extinguishing start temperature, the state where closure section 801 is provided in fire extinguishing board 201 is maintained. Thus, the refrigerant having entered void 202 from circulation path 106 is output to circulation path 106 without being emitted to the exterior of fire extinguishing section 800. In addition, under an environment of the fire extinguishing start temperature or above, closure section 801 is melted by heat. Thus, the refrigerant having entered void 202 from circulation path 106 is emitted out of fire extinguishing section 800.

A predetermined pressure is exerted on closure section 801 by the refrigerant having entered void 202, and therefore, closure section 801 is so provided in fire extinguishing board 201 as not to be dropped off from fire extinguishing board 201 by the pressure of the refrigerant under an environment of a temperature below the fire extinguishing start temperature.

### <Fire Extinguishing Method>

A fire extinguishing method in Embodiment 4 of the present invention is described with reference to FIG. 8.

Referring to FIG. 8, closure section 801 is heated and melted by fire when fire occurs at device 301, under an environment of the fire extinguishing start temperature or above. At this time, when screw thread 801b of side wall 801a is melted, closure section 801 is drops off from fire extinguishing board 201, or a gap is defined between side wall 801a and wall section 201a. Accordingly, through the through hole defined after closure section 801 drops off, or through the through hole in the form of the gap defined between side wall 801a and wall section 201a, the refrigerant can be emitted out of void 202.

It is to be noted that the other points of the fire extinguishing method in the present embodiment are same as in Embodiment 1, and the description thereof is omitted.

### <Effect of the Present Embodiment>

According to the present invention, fire or the like can be surely extinguished by performing fire extinguishing without using a sensor to detect temperature changes.

In addition, according to the present embodiment, since the closure section is threadedly engaged with the fire extinguishing board, it is possible to securely prevent the closure section from dropping off due to the shock and the pressure of the refrigerant applied to the in-vehicle fire extinguishing apparatus.

In addition, according to the present embodiment, the refrigerant is emitted to the exterior when the screw thread of the side wall of the closure section is melted. Thus, the closure section can be melted with low energy, and fire can be extinguished at an early stage.

In addition, according to the present embodiment, when a pressure-regulating valve is provided in the fire extinguishing section, it is possible to prevent the closure section from being dropped off from the fire extinguishing board by the pressure of the refrigerant exerted on the closure section, under an environment of a temperature below the fire extinguishing start temperature.

### Embodiment 5

### Configuration of Fire Extinguishing Section

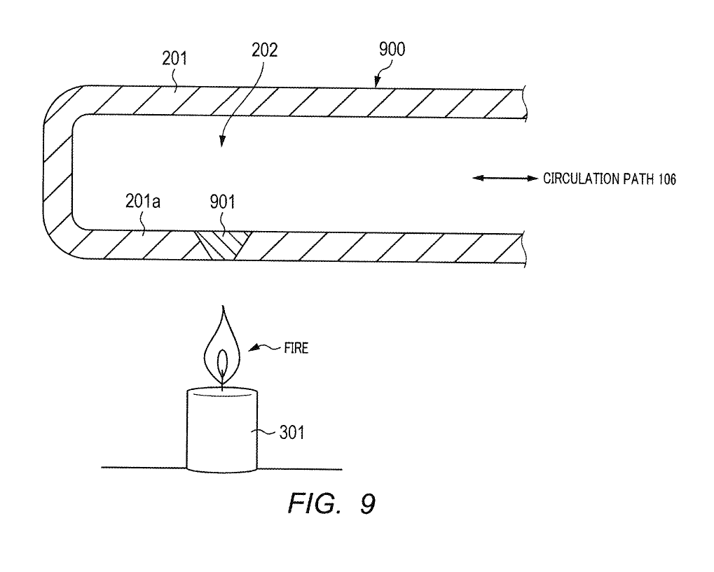

The configuration of fire extinguishing section 900 in Embodiment 5 of the present invention is described with reference to FIG. 9. FIG. 9 is an enlarged sectional view of a main part of fire extinguishing section 900 in the present embodiment.

As compared with fire extinguishing section 104 according to Embodiment 1 illustrated in FIG. 2 and FIG. 3, fire extinguishing section 900 illustrated in FIG. 9 includes closure section 901 in place of closure section 203. It is to be noted that, in FIG. 9, the same reference numerals are attached to the components same as those in FIG. 2 to FIG. 4, and the descriptions thereof are omitted. In addition, the configuration of the in-vehicle fire extinguishing apparatus according to the embodiment of the present embodiment is same as that of FIG. 1, and the description thereof is omitted.

Fire extinguishing section 900 includes fire extinguishing board 201, void 202, and closure section 901.

Fire extinguishing board 201 is provided with closure section 901.

Closure section 901 is formed of a material different from that of fire extinguishing board 201. Closure section 901 is formed of a material that is melted by a temperature greater than the fire extinguishing start temperature, and closure section 901 is attached to fire extinguishing board 201. The material of closure section 901 is same as that of closure section 203 of Embodiment 1, and the description thereof is omitted.

Closure section 901 is provided in wall section 201a that separates void 202 from the exterior in fire extinguishing section 900. As viewed in the thickness cross-section of wall section 201a, closure section 901 has a form tapering from void 202 toward the exterior of fire extinguishing section 900. When provided in wall section 201a, closure section 901 seals void 202 from the exterior.

Under an environment of a temperature below the fire extinguishing start temperature, the state where closure section 901 is provided in fire extinguishing board 201 is maintained. Thus, the refrigerant having entered void 202 from circulation path 106 is output to circulation path 106 without being emitted to the exterior of fire extinguishing section 900. In addition, under an environment of the fire extinguishing start temperature or above, closure section 901 is melted by heat. Thus, the refrigerant having entered void 202 from circulation path 106 is emitted out of fire extinguishing section 900.

It is to be noted that the other points of the fire extinguishing method in the present embodiment are same as in Embodiment 1, and the description thereof is omitted.

### <Effect of the Present Embodiment>

According to the present invention, fire or the like can be surely extinguished by performing fire extinguishing without using a sensor to detect temperature changes.

In addition, according to the present embodiment, the closure section has a form tapering from the interior toward the exterior of the fire extinguishing section as viewed in the thickness cross-section of the wall section. Thus, it is possible to prevent the closure section from dropping off from the fire extinguishing board when the pressure of the refrigerant is increased in the state where fire is not caused.

In addition, according to the present embodiment, when a pressure-regulating valve is provided in the fire extinguishing section, it is possible to prevent the closure section from being dropped off from the fire extinguishing board by the pressure of the refrigerant exerted on the closure section, under an environment of a temperature below the fire extinguishing start temperature.

### <Modification Common to All Embodiments>

While the refrigerant is emitted to the exterior when the closure section is melted in the above-mentioned Embodiments 1 to 5, the present invention is not limited to this, and the refrigerant may be emitted to the exterior when the entirety of the fire extinguishing section is melted. In this case, the closure section is unnecessary.

In addition, while the fire extinguishing section is provided in the circulation path between the expansion valve and the evaporator in the above-mentioned Embodiment 1 to embodiment 5, the present invention is not limited to this, and the fire extinguishing section may be provided between the evaporator and the compressor.

In addition, while a plurality of the closure sections are provided in the above-mentioned Embodiments 1 to 5, the present invention is not limited to this, and the number of the closure section may be one.

This application is entitled to and claims the benefit of Japanese Patent Application No. 2012-068961 dated Mar. 26, 2012, the disclosure of which including the specification, drawings and abstract is incorporated herein by reference in its entirety.

### INDUSTRIAL APPLICABILITY

The in-vehicle fire extinguishing apparatus according to the embodiments of the present invention is suitable for use in performing fire extinguishing by utilizing an air conditioning apparatus that heats or cools the vehicle interior.

### REFERENCE SIGNS LIST

100 In-vehicle fire extinguishing apparatus
101 Compressor
102 Condenser
103 Expansion valve
104 Fire extinguishing section
105 Evaporator
106 Circulation path
150 Air conditioning section

1. An in-vehicle fire extinguishing apparatus configured to perform fire extinguishing by utilizing an air conditioning apparatus that heats or cools a vehicle interior, the in-vehicle fire extinguishing apparatus comprising:
an incombustible or flame-retardant refrigerant;
a compressor that compresses the refrigerant in such a manner as to increase a temperature and a pressure of the refrigerant;
a condenser that causes a high-temperature and high-pressure refrigerant compressed by the compressor to release heat;
an expansion valve that expands the refrigerant that is caused to release heat by the condenser in such a manner as to reduce the temperature and the pressure of the refrigerant;
an evaporator that causes a low-temperature and low-pressure refrigerant expanded by the expansion valve to absorb heat;
a circulation path that causes the refrigerant output from the compressor to enter the compressor through the condenser, the expansion valve, and the evaporator; and
a fire extinguishing section provided in the circulation path between the expansion valve and the compressor, the fire extinguishing section allowing the refrigerant entered from the circulation path to be output to the circulation path under an environment of a temperature below a predetermined temperature equal to or greater than a guaranteed temperature of a device mounted in a vehicle, and emitting the refrigerant entered from the circulation path to an exterior so as to perform fire extinguishing by being melted under an environment of a temperature equal to or greater than the predetermined temperature.

2. The in-vehicle fire extinguishing apparatus according to claim 1, wherein the device is a motor, a charger, a battery, or an ECU, not an engine.

3. The in-vehicle fire extinguishing apparatus according to claim 1, wherein
the fire extinguishing section includes a closure section that seals from an exterior an interior in which the refrigerant flows, and
the closure section melts under the environment of a temperature equal to or greater than the predetermined temperature to connect the interior with the exterior of the fire extinguishing section and to emit the refrigerant entered from the circulation path to the exterior.

4. The in-vehicle fire extinguishing apparatus according to claim 3, wherein the closure section is provided in a wall section that separates the exterior from the interior of the fire extinguishing section, the closure section having a square form or a rectangular form as viewed in a thickness cross-section of the wall section.

5. The in-vehicle fire extinguishing apparatus according to claim 3, wherein the closure section is engaged by irregularity with a wall section that separates the exterior from the interior of the fire extinguishing section.

6. The in-vehicle fire extinguishing apparatus according to claim 3, wherein the closure section is threadedly engaged with a wall section that separates the exterior from the interior of the fire extinguishing section.

7. The in-vehicle fire extinguishing apparatus according to claim 3, wherein the closure section is provided in a wall section that separates the exterior from the interior of the fire extinguishing section, the closure section having a form tapering from the exterior toward the interior of the fire extinguishing section as viewed in a thickness cross-section of wall section.

8. The in-vehicle fire extinguishing apparatus according to claim 3, wherein the closure section is provided in a wall section that separates the exterior from the interior of the fire extinguishing section, the closure section having a form tapering from the interior toward the exterior of the fire extinguishing section as viewed in a thickness cross-section of wall section.
